(19) United States
(12) Patent Application Publication
(10) Pub. No.: US 2022/0192349 A1
(43) Pub. Date: Jun. 23, 2022

(54) Convertible Backpack Shelter Device

(71) Applicant: Jeffrey Delp, Charlotte, NC (US)

(72) Inventor: Jeffrey Delp, Charlotte, NC (US)

(21) Appl. No.: 17/555,304

(22) Filed: Dec. 17, 2021

Related U.S. Application Data
(60) Provisional application No. 63/127,097, filed on Dec. 17, 2020.

(51) Int. Cl. A45F 4/04; E04H 15/14; E04H 15/00; E04H 15/20; F21S 9/03; F21V 33/00

(52) U.S. Cl. CPC A45F 4/04; E04H 15/14; E04H 15/008; E04H 2015/208; F21S 9/035; F21V 33/006; E04H 15/20

(57) ABSTRACT

A convertible backpack shelter device is provided. The convertible backpack shelter device includes a housing compartment. The housing compartment is formed by a number of walls. Each wall of the number of walls are collapsible into a stored configuration and an extended configuration. The number of walls includes a top wall disposed oppositely a bottom wall, with a plurality of intermediate walls extending between the top wall and the bottom wall. The intermediate walls include a back wall and a front wall. A pair of shoulder straps are placed on the back wall.

### CROSS REFERENCE TO RELATED APPLICATIONS

This application claims the benefit of U.S. Provisional Application No. 63/127,097 filed on Dec. 17, 2020. The above identified patent application is herein incorporated by reference in its entirety to provide continuity of disclosure.

### BACKGROUND OF THE INVENTION

The present invention relates to a convertible backpack shelter device. More specifically, the present invention provides a backpack that can be converted into a shelter for the wearer to occupy.

Hiking, camping, backpacking and other adventurous activities have always been, and continue to be, popular among people of all ages. When preparing for hiking and camping trips, hikers and campers try to pack as many things into their carrying bags or backpacks as possible without having to carry too much additional weight. One piece of equipment that the hikers and campers would have to carry on long trips is a shelter structure that will protect the individual from the elements while they are sleeping or resting. For example, a sleeping bag or a tent can provide the user with the proper means to shelter themselves while hiking and camping. However, these types of shelter structures can take up a lot of space in a carrying bag or backpack and be additional weight that the hiker or camper must carry. Due to the necessity of the hiker or camper to have a means of shelter for extended trips, it makes it harder for them to pack other equipment that might be less essential but could provide assistance because of the limited space that is in carrying bags or backpacks. Providing users with a means to carry a sheltering device without taking up space or increasing the weight in a carrying bag or backpack will allows the users to carry additional equipment.

Shelter structures, such as tents, can be difficult for hikers and campers to erect. For tents that require a lot of instructions to set up, it can be frustrating and time-consuming for the hiker or camper. Sometimes, a hiker or camper may need to set up a tent in a short amount of time to prevent himself or herself from getting cold or wet, but some of the tents can take a lot of time to set up. Providing users with a means to set up a sheltering device quickly will prevent them from prolonged exposure to low temperatures or poor weather conditions. In order to address these concerns, the present invention will provide users with a multipurpose outdoor backpack capable of being quickly converted into an insulated structure.

### SUMMARY OF THE INVENTION

In view of the foregoing disadvantages inherent in the known types of stowable structures now present in the prior art, the present invention provides a convertible backpack shelter device wherein the same can be utilized for providing convenience for the user when transporting and setting up a sheltering structure.

The present system comprises a housing compartment. The housing compartment comprises a plurality of walls. The plurality of walls is collapsible into a stored configuration and an extended configuration. The plurality of walls comprises a top wall disposed oppositely a bottom wall, with a plurality of intermediate walls extending therebetween. The intermediate walls, themselves, comprise a back wall and a front wall. A pair of shoulder straps are disposed on the back wall.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the convertible backpack shelter device in a stored configuration.

FIG. 2 shows a perspective view of an embodiment of the convertible backpack shelter device in an extended configuration.

FIG. 3 shows a close-up view of an embodiment of the convertible backpack shelter device in an extended configuration.

FIG. 4 shows a close-up view of an embodiment of the convertible backpack shelter device in a stored configuration.

### DETAILED DESCRIPTION OF THE INVENTION

Reference is made herein to the attached drawings. Like reference numerals are used throughout the drawings to depict like or similar elements of the convertible backpack shelter device. The figures are intended for representative purposes only and should not be considered to be limiting in any respect.

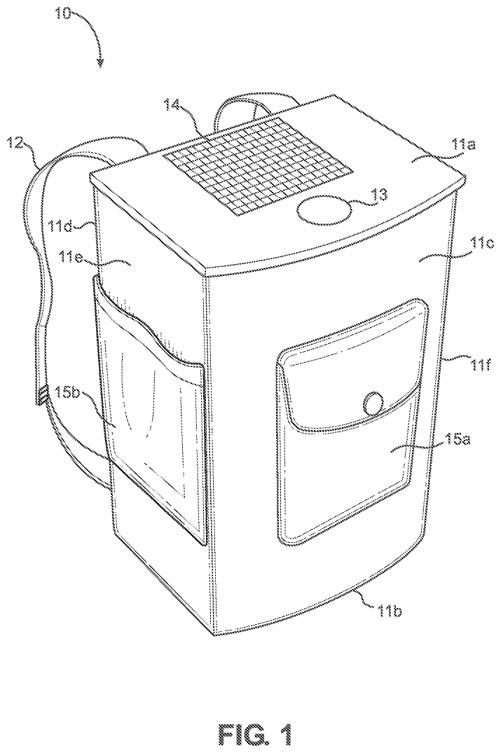

Referring now to FIG. 1, there is shown a perspective view of an embodiment of the convertible backpack shelter device in a stored configuration. The convertible backpack shelter device 10 comprises a plurality of walls 11a, 11b, 11c, 11d, 11e, 11f. The plurality of walls 11a, 11b, 11c, 11d, 11e, 11f comprise a top wall 11a disposed opposite a bottom wall 11b with a plurality of intermediate walls 11c, 11d, 11e, 11f extending in between, from the top wall 11a to the bottom wall 11b. In the illustrated embodiment, the plurality of intermediate walls 11c, 11d, 11e, 11f consists of a front wall 11c disposed opposite of a back wall 11d with a pair of side walls 11e, 11f disposed therebetween. The plurality of walls 11a, 11b, 11c, 11d, 11e, 11f define a housing compartment. The housing compartment is configured to receive a plurality of items therein. In the illustrated embodiment, the top wall 11a is removably securable to the housing compartment via a fastener, such as a zipper. As such, the top wall 11a may be removed fully or partially to allow access to the interior cavity of the housing compartment.

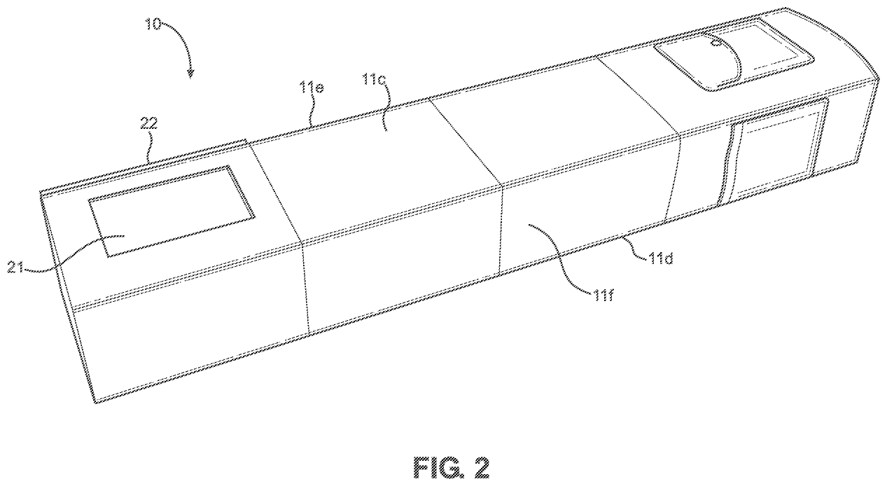

The plurality of walls 11a, 11b, 11c, 11d, 11e, 11f are collapsible into a stored configuration (shown in FIG. 1) and extendable into an extended configuration (shown in FIG. 2). The stored configuration is defined where the plurality of intermediate walls 11c, 11d, 11e, 11f are in a collapsed, relatively shorter position. The plurality of intermediate walls 11c, 11d, 11e, 11f may be collapsed by any suitable means. For example, the plurality of intermediate walls 11c, 11d, 11e, 11f may be telescopically collapsible or foldable through a series of alternating folds.

When in the stored configuration, the convertible backpack shelter device 10 is usable as a backpack. As such, the user may load items into the housing compartment formed by the plurality of walls 11a, 11b, 11c, 11d, 11e, 11f. In the illustrated embodiment, the convertible backpack shelter device 10 further comprises a pair of shoulder straps 12. The pair of shoulder straps 12 are disposed on the back wall 11d of the housing compartment. The pair of shoulder straps 12 are configured to receive the arms of the user therethrough, thus securing the housing compartment to the back of the user. Alternatively, another method of securing the housing compartment to the user may be utilized, such as a single strap dimensioned to cross the body of the user.

In the illustrated embodiment, the convertible backpack shelter device 10 further comprises an air vent 13. The air vent 13 is disposed on the top wall 11a of the housing compartment. The air vent 13 is configured to maximize air flow through the housing compartment. When the convertible backpack shelter device 10 is being utilized as a personal shelter, the air vent 13 will prevent the potentially uncomfortable build-up of humidity within the housing compartment.

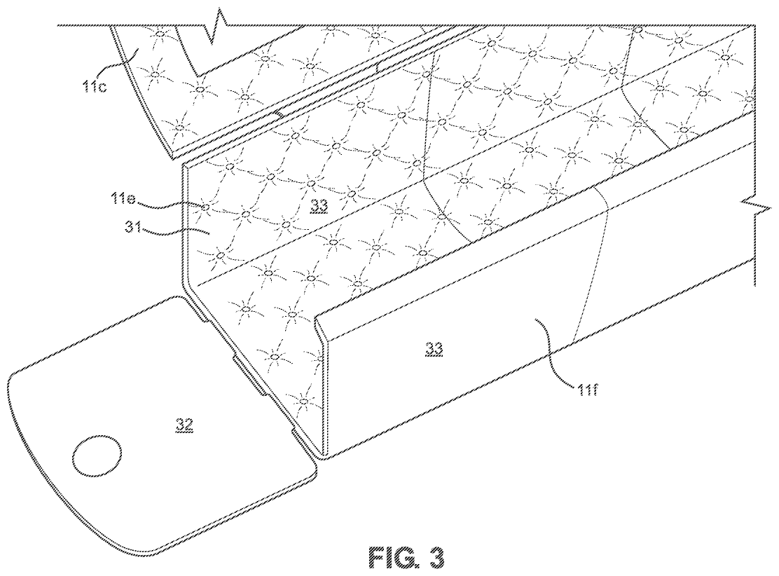

In some embodiments, the convertible backpack shelter device 10 comprises a power storage unit. The power storage unit is of any suitable configuration for storing electric power while being storable within the convertible backpack shelter device 10. For example, the power storage unit may be a battery. The power storage unit may be stored within the top wall 11d of the housing compartment (shown as 32 in FIG. 3) or may be placed in another suitable position. In the illustrated embodiment, the power storage unit is in operable connection with a solar panel 14. The solar panel 14 is disposed on an external surface of the top wall 11d of the housing compartment, such that the solar panel 14 will receive ultraviolet radiation from an overhead sun.

Additionally, in the illustrated embodiment, a plurality of pockets 15 are disposed on a plurality of external surfaces of the plurality of intermediate walls, 11c, 11d, 11e, 11f. The plurality of pockets 15 can comprise pockets of any size or configuration. For example, the plurality of pockets 15 can comprise pockets with closeable flaps 15a to allow for additional security of items or pockets with openings at the top 15b to allow for easier access to the items stored in the pocket. In the illustrated embodiment, the plurality of pockets 15 are placed at a bottom portion of the housing compartment. As such, when the convertible backpack shelter device 10 is placed into the extended configuration the plurality of pockets will be disposed at the portion of the housing compartment corresponding to the feet of the user.

Referring now to FIG. 2, there is shown a perspective view of an embodiment of the convertible backpack shelter device in an extended configuration. In the illustrated embodiment, the convertible backpack shelter device 10 is placed into the extended configuration. The extended configuration is defined where the plurality of intermediate walls 11c, 11d, 11e, 11f are extended to be longer relative to their respective lengths when the convertible backpack shelter device 10 is in the stored configuration (shown in FIG. 1). As such, when in the extended configuration, the convertible backpack shelter device 10 can be utilized as a personal shelter. In the illustrated embodiment, a sealable opening 22 is defined between the front wall 11c and a side wall 11e, such as to assist the user with getting into and out of the convertible backpack shelter device 10.

In the illustrated embodiment, the plurality of walls 11a, 11b, 11c, 11d, 11e, 11f are rigid. As such, when in the extended configuration, the convertible backpack shelter device 10 will define a free-standing structure in which the user may rest. Furthermore, the plurality of walls 11a, 11b, 11c, 11d, 11e, 11f are secured to each other such as to form a waterproof compartment to prevent water from entering the convertible backpack shelter device 10.

In the illustrated embodiment, the convertible backpack shelter device 10 further comprises a transparent portion 21. The transparent portion 21 is disposed on the front wall 11c of the housing compartment. The transparent portion 21 is configured to allow for natural light to enter the housing compartment when the convertible backpack shelter device 10 is being utilized as a personal shelter. Structurally, the transparent portion 21 may be made of a vinyl material or any other suitable material for enabling light to pass through the convertible backpack shelter device 10. In the shown embodiment, the transparent portion 21 is placed at a top portion of the front wall 11c of the housing compartment, such as to position the transparent portion above where the head of the user would be when the user is resting in the housing compartment.

Referring now to FIG. 3, there is shown a close-up view of an embodiment of the convertible backpack shelter device in an extended configuration. In the illustrated embodiment, a reflective material 31 is dispose on an interior surface of the plurality of walls 11a, 11b, 11c, 11d, 11e, 11f. The reflective material 31 is configured to prevent heat loss from the internal housing of the convertible backpack shelter device 10. In addition to the reflective material 31, the convertible backpack shelter device 10 can further comprise additional insulation materials to further insulate the housing compartment for the user. Furthermore, in some embodiments, a plurality of lights 33 may be disposed within the housing compartment to provide light to the user. The plurality of lights 33 are in operable connection with the power storage unit 32, such that power gathered from the solar panel may be used to power the plurality of lights 33.

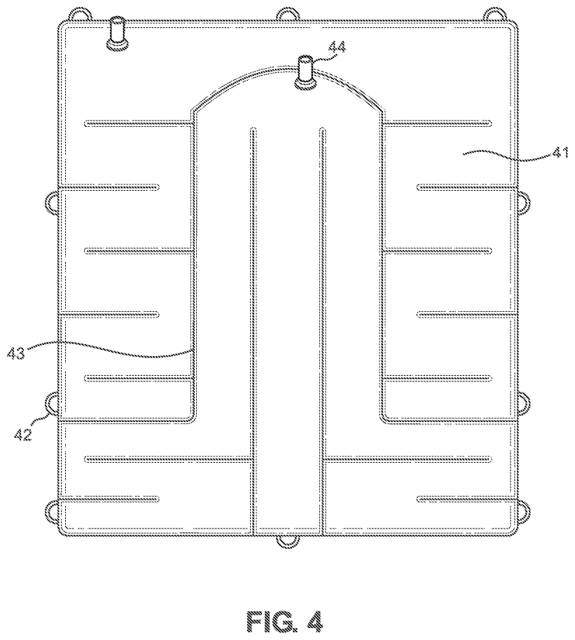

Referring now to FIG. 4, there is shown a close-up view of an embodiment of the convertible backpack shelter device in a stored configuration. In the illustrated embodiment, the convertible backpack shelter device 10 further comprises an inflatable pad 41. The inflatable pad 41 is securable to the back wall of the housing compartment. As such, the inflatable pad 41 provides cushioning to the back of the user when carrying the convertible backpack shelter device 10 in a stored configuration or laying on the convertible backpack shelter device 10 in an extended configuration. The inflatable pad 41 may be secured to the housing compartment via a plurality of attachment rings 42 or by any other suitable means. A plurality of baffles 43 may be provided in order to direct the air flow through the inflatable pad 41. Additionally, the inflatable pad 41 may be manually inflatable via an air valve 44 or via another mechanism.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A convertible backpack shelter device, comprising:
a housing compartment comprising a plurality of walls;
the plurality of walls collapsible into a stored configuration and extendable into an extended configuration;
the plurality of walls comprising a top wall disposed oppositely a bottom wall with a plurality of intermediate walls extending therebetween;
the intermediate walls comprising a back wall and a front wall;
a pair of shoulder straps disposed on the back wall.

2) The convertible backpack shelter device of claim 1, wherein each of the plurality of walls are rigid.

3) The convertible backpack shelter device of claim 1, wherein the plurality of walls form a waterproof compartment.

4) The convertible backpack shelter device of claim 1, wherein the plurality of walls comprise a reflective material disposed on an internal surface thereof.

5) The convertible backpack shelter device of claim 1, wherein at least one air vent is disposed on the plurality of walls.

6) The convertible backpack shelter device of claim 1, wherein the air vent is disposed on the top wall.

7) The convertible backpack shelter device of claim 1, wherein at least one transparent portion is defined on the plurality of walls.

8) The convertible backpack shelter device of claim 1, further comprises a power storage unit.

9) The convertible backpack shelter device of claim 8, wherein the power storage unit is in operable connection with a solar panel disposed on an external surface of the housing compartment.

10) The convertible backpack shelter device of claim 9, wherein the solar panel is disposed on the external surface of the top wall.

11) The convertible backpack shelter device of claim 1, wherein a plurality of pockets is disposed on an external surface of the plurality of walls.

12) The convertible backpack shelter device of claim 1, further comprising a plurality of lights disposed on an interior surface of the housing compartment.

13) The convertible backpack shelter device of claim 1, wherein the top wall is removably securable to the housing compartment via a fastener.

14) The convertible backpack shelter device of claim 1, further comprising an inflatable pad disposed on the back wall.
